(19) United States
(12) Patent Application Publication
(10) Pub. No.: US 2020/0213243 A1
(43) Pub. Date: Jul. 2, 2020

(54) REGULATING SCHEDULER

(71) Applicant: Sangmyung University Industry-Academy Cooperation Foundation, Seoul (KR)

(72) Inventor: Jinoo Joung, Seoul (KR)

(21) Appl. No.: 16/357,539

(22) Filed: Mar. 19, 2019

(30) Foreign Application Priority Data
Dec. 27, 2018 (KR) 10-2018-0170452

(51) Int. Cl. H04L 12/873; H04L 12/865; H04L 12/863; H04L 12/875; G06F 9/455

(52) U.S. Cl. CPC H04L 47/527; H04L 47/6275; G06F 2009/45595; H04L 47/56; G06F 9/45558; H04L 47/6225

(57) ABSTRACT

The present disclosure provides a regulating scheduler of a relaying node provided at an output port of the relaying node, wherein the scheduler performs scheduling by generating a virtual packet in a queue in which traffic is stored, to allow the queue to be continuously served more than actually incoming traffic and prevent burst from increasing due to an arbitrary queue being served all at once, and the served virtual packet is not outputted to the output port, so that the scheduler has non-working-conserving characteristics.

### CROSS-REFERENCE TO RELATED APPLICATION

This application claims priority of Korean Patent Application No. 10-2018-0170452, filed on Dec. 27, 2018, in the KIPO (Korean Intellectual Property Office), the disclosure of which is incorporated herein entirely by reference.

### BACKGROUND OF THE INVENTION

### Field of the Invention

The present disclosure relates to a regulating scheduler of a relaying node provided at an output port of the relaying node.

### Description of the Related Art

Various applications such as smart factory, inter-vehicle network, in-vehicle network, professional AV network and wide-area power control network require strict bounds for end-to-end network delay, ranging from a few milliseconds to a few seconds. Accordingly, solutions based on flow-based schedulers in the Integrated Services (IntServ) framework have been proposed. However, classifying and scheduling a large amount of flows is difficult to implement due to high complexity. In networks including class-based schedulers as an alternative, bursts continuously increase across nodes, and in network topologies with cycle, bursts grow infinitely, making it impossible to limit the delay. Accordingly, there are emerging technologies in which a traffic regulator and a class-based scheduler are placed at front and back positions to limit the burst size and lower the complexity of the scheduler, thereby guaranteeing end-to-end delay of a predetermined level or lower. However, this regulator that operates based on the flow hinders the simplicity of the class-based scheduler.

### SUMMARY OF THE INVENTION

The corresponding technical field requires an approach for guaranteeing the maximum delay of a predetermined level or lower even in a wide area network with simpler configuration.

To solve the above-described technical problem, an embodiment of the present disclosure provides a regulating scheduler.

The regulating scheduler is a scheduler of a relaying node provided at an output port of the relaying node, wherein the scheduler performs scheduling by generating a virtual packet in a queue in which traffic is stored, to allow the queue to be continuously served more than actually incoming traffic and prevent burst from increasing due to an arbitrary queue being served all at once, and the served virtual packet is not outputted to the output port, so that the scheduler has non-working-conserving characteristics.

Furthermore, the regulating scheduler is a non-work conserving regulating scheduler provided at an output port of a relaying node, wherein the scheduler performs scheduling for a plurality of first traffics having high priority on the basis of a preset reference and a second traffic having low priority on the basis of the reference according to a scheduling algorithm, the first traffics divided per input port of the relaying node, and the scheduler performs scheduling by generating a virtual packet so that queue becomes non-empty, the queue in which each independent traffic of the plurality of first traffics and the second traffic is stored, and the served virtual packet is not outputted to the output port, so that the scheduler has non-work conserving characteristics.

In addition, the above-described technical solutions do not enumerate all the features of the present disclosure. These and other features and their advantages and effects will be particularly understood by referring to the following specific embodiments.

According to an embodiment of the present disclosure, the scheduler can realize the regulation function as well and implement based on the input port, thereby guaranteeing the maximum delay within a few msec even in a wide area network with simpler configuration.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a diagram showing the structure of a node including a regulating scheduler and flow aggregates in the node according to an embodiment of the present disclosure.

FIG. 2 is a diagram showing the structure of a scheduler according to an embodiment of the present disclosure.

FIG. 3 is a diagram showing the structure of a node including a scheduler and flow aggregates when a deficit round robin (DRR) algorithm is applied according to an embodiment of the present disclosure.

FIGS. 4 and 5 are diagrams showing changes in the maximum delay with the changing maximum packet size in a regulating scheduler according to an embodiment of the present disclosure.

FIG. 6 is a diagram showing changes in the maximum delay with the changing quantum size in a regulating scheduler according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

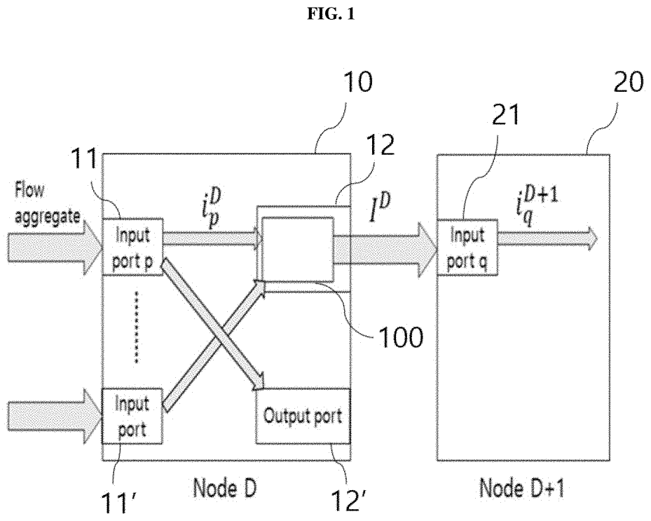

FIG. 1 is a diagram showing the structure of a node including a regulating scheduler and flow aggregates in the node according to an embodiment of the present disclosure.

Referring to FIG. 1, the regulating scheduler 100 according to an embodiment of the present disclosure is provided at an output port 12 of a relaying node 10, and performs scheduling by generating a virtual packet in a queue in which traffic is stored, so that the queue is continuously served more than actually incoming traffic. Accordingly, it is possible to prevent bursts from increasing due to an arbitrary queue being served all at once. This corresponds to the regulation function, and eliminates the need to implement a separate regulator. Additionally, the served virtual packet is not outputted to the output port, and thus, the scheduler 100 has non-working-conserving characteristics.

Additionally, the scheduler 100 is disposed within the output port 12 of the relaying node 10, and may perform regulation and scheduling based on the input port, not based on the flow. Accordingly, complexity of implementation may be greatly reduced.

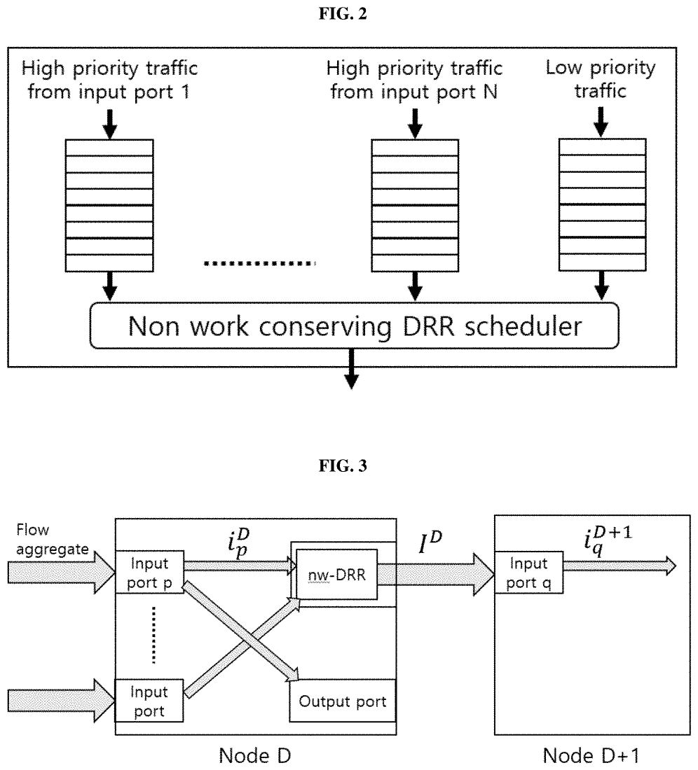

In detail, in the scheduler 100, the whole traffic may be divided into first traffic having high priority and second traffic having low priority on the basis of a preset reference according to priority. Additionally, the first traffic having high priority at the output port 12 of the relaying node 10 (for example, a switch) may be divided for each input port 11, 11′. That is, the whole traffic is divided into a plurality of first traffics that are divided per input port and a second traffic and each of them is an independent traffic, and these traffics may be simultaneously processed as described below. For example, in the case of n input ports, n+1 traffics including n first traffics and a second traffic are generated. FIG. 2 is a diagram showing the structure of the scheduler according to an embodiment of the present disclosure, and shows the structure of the scheduler having a plurality of first traffics and a second traffic.

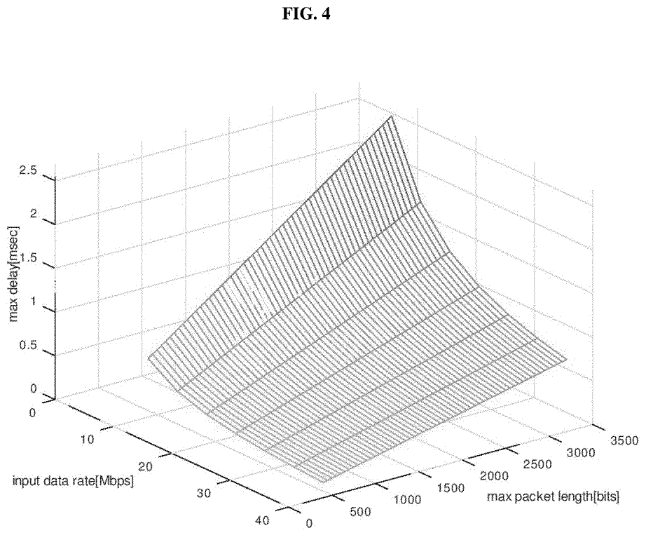

The scheduler 100 may schedule and serve the generated n+1 traffics according to a scheduling algorithm (for example, a deficit round robin (DRR) algorithm). In this case, the scheduler 100 may perform scheduling by generating virtual packets so that queue, in which each traffic is stored, becomes non-empty. FIG. 3 is a diagram showing the structure of the node including the scheduler and the flow aggregates when a DRR algorithm is applied according to an embodiment of the present disclosure. The non-work conserving DRR scheduler shown in FIG. 3 is an embodiment, and a different type of non-work-conserving scheduler may replace it.

In other words, the scheduler 100 that performs a non-work conserving scheduling function based on the input port is disposed at each output port of the relaying node.

The scheduler 100 disposed at the output port of the relaying node may operate as below. In the following embodiment, the case in which the scheduler 100 performs scheduling according to the DRR algorithm is described as an example. However, the present disclosure is not necessarily limited to the DRR algorithm, and the spirit of the present disclosure may be applied to various known scheduling algorithms.

1. The second traffic v that carries the low priority arriving without a predefined arrival rate may be treated as having an arrival rate as much as a difference of the sum of arrival rates of the plurality of first traffics of high priority and the capacity of the scheduler

$$( {ρ}_{v} = r - {\sum }_{i} {ρ}_{1} ) .$$

2. During the “scheduler 100 backlog period”, when there are one or more actual packets in the scheduler, all the queues have to be backlogged, with virtual packets if necessary. To make queues of all the traffics including the plurality of first traffics of high priority and the second traffic of low priority be always backlogged, when a queue of a corresponding traffic is empty immediately before the queue's turn, the variables of the queue may be initialized (i.e., the deficit value may be set to a predefined value) and then a virtual packet may be generated. Here, the size of the generated virtual packet may be the quantum size of the corresponding queue. In other word, the virtual packet of the maximum size that can be served in a single round may be generated. The service order of the traffics may be different for different scheduler backlog periods.

3. When an actual packet arrives at the queue of the corresponding traffic while the generated virtual packet is being served, the service of the virtual packet may be immediately stopped, and the variables of the queue may be initialized (i.e., the deficit value may be set to a predefined value), and then the next queue may be served.

4. Meanwhile, even though the service of the virtual packet is completed, the virtual packet does not leave the scheduler.

In the scheduler that operates as described above, all the traffics are processed in a non-work conserving manner. That is, all the queues are always backlogged, and the sum of arrival rates of all the traffics is equal to the capacity of the scheduler.

The performance of the above-described scheduler is theoretically analyzed as follows.

Theorem 1

Assume that traffic i is continuously backlogged during time period (a,b]. Assume that the traffic i is served k turns during (a,b]. The total amount Wᵢ(a,b) of service given to the traffic i during this period is bounded as below.

kϕᵢ−δᵢ^{k}≤Wᵢ(a,b)≤kϕᵢ+δᵢ⁰

δᵢ^{k} where is the deficit value at the finish time of k^{th} round, counting from the first round during (a,b] of i.

1. Proof

See the proof of Theorem 4.2 in the paper about DRR—M. Shreedhar et al., “Efficient fair queueing using deficit round-robin”, IEEE/ACM Transaction on Networking, Vol. 4, No.3, June 1996, pp. 375-385.

Theorem 2

The total amount of service that the DRR scheduler gives to the traffic during an arbitrary period (a,b] of the backlog period is bounded as below.

$${W}_{i} ( a , b ) \leq {ρ}_{i} \frac{{F}_{max}}{f} ( b - a ) + {φ}_{i} + {L}_{i}$$

where f is the sum of quantum values of queues that are continuously backlogged during this period, and Fₘₐₓ is the sum of quantum values in an imaginary situation where the arrival rates of the traffics is equal to the capacity of the scheduler.

2. Proof

Here, the backlog period is the period during which a packet of high priority traffic is actually in a queue. Let tₖ be the finish time of k^{th} round counting from a, and t₀=a. The duration of a round, i.e., the length of (tₖ₋₁,tₖ] is

$${t}_{k} - {t}_{k - 1} = \frac{1}{r} {\sum }_{j ∈ {B}_{k}} ( {φ}_{j} + {δ}_{j}^{k - 1} - {δ}_{j}^{k} )$$

where Bₖ is a set of traffics that are backlogged and served during (tₖ₋₁,tₖ]. During (tₖ₋₁,tₖ], the elements of Bₖ are not changed. When B is defined as a set of traffics that are continuously backlogged during (t₀,tₖ], B⊂Bₖ for all k. In this case, the following equation is given.

$${t}_{k} - {t}_{k - 1} \geq \frac{1}{r} {\sum }_{j ∈ B} ( {φ}_{j} + {δ}_{j}^{k - 1} - {δ}_{j}^{k} )$$

Summing up the inequality for all k, we get

$${t}_{k} - {t}_{0} \geq k \frac{f}{r} + \frac{1}{r} {\sum }_{j ∈ B} ( {δ}_{j}^{0} - {δ}_{j}^{k} ) \geq \frac{f}{r} ( k - 1 ) ,$$

since Σ_{j∈B}δⱼ⁰≥0 and Σ_{j∈B}δⱼ^{k}≤f. Therefore k≤r/f(tₖ−t₀)−1. From Theorem 1, during (t₀,tₖ],

$${W}_{i} ( {t}_{0} , {t}_{k} ) \leq k {φ}_{i} + {δ}_{i}^{0} \leq \frac{r}{f} ( {t}_{k} - {t}_{0} ) {φ}_{i} + {φ}_{i} + {δ}_{i}^{0} \leq {ρ}_{i} \frac{{F}_{max}}{f} ( {t}_{k} - {t}_{0} ) + {φ}_{i} + {L}_{i}$$

because Lᵢ≥δᵢ⁰ and ρᵢ/r=ϕᵢ/Fₘₐₓ. In other words, the deficit values cannot be larger than the maximum packet length Lᵢ all the time including t₀. The arrival rate of the traffic is proportional to the quantum value, and Fₘₐₓ is the frame size when the arrival rates of the traffics are equal to the capacity of the scheduler, and thus is proportional to r. Therefore, for an arbitrary time b between tₖ and tₖ₊₁,

$${W}_{i} ( a , b ) = {W}_{i} ( a , {t}_{k} ) \leq {ρ}_{i} \frac{{F}_{max}}{f} ( {t}_{k} - a ) + {φ}_{i} + {L}_{i} \leq {ρ}_{i} \frac{{F}_{max}}{f} ( b - a ) + {φ}_{i} + {L}_{i}$$

and Theorem 2 is given.

Meanwhile, according to Theorem 2, when the sum of arrival rates of the traffics backlogged during (a,b] is equal to the capacity of the scheduler, the service for the traffic i is bounded as below.

Wᵢ(a,b)≤ρᵢ(b−a)+ϕᵢ+Lᵢ

Accordingly, the above-described scheduler has an effect of traversing a regulator with the bucket size of ϕᵢLᵢ because the total amount of service per hour is limited in an arbitrary time period. The maximum burst of flow aggregate i for each input port across the above-described scheduler is ϕᵢLᵢ , and ϕᵢ is the size of quantum allocated to the corresponding flow aggregate. When queues are allocated for each input port and applied to the scheduling algorithm like the present disclosure as described above, complexity is so much lower than that of application for each traffic, and as a result, the quantum size may be reduced.

Theorem 3

The above-described scheduler is an “LR server” and provides the same latency and service rate as a DRR scheduler.

3. Proof

Assume n traffics arrive at the scheduler. It is sufficient to prove that for all packets in an arbitrary traffic i, i∈{1, . . . , n}, there exists a DRR system that provides the same service as the service of the above-described scheduler. Packets arrive during the backlog period of i are pₖ, k=0, 1, . . . , K. p₀ arrives to a queue with a virtual packet, but the above-described scheduler removes the corresponding virtual packet immediately before the arrival of p₀. If the corresponding virtual packet is being served, the above-described scheduler removes the corresponding virtual packet and then proceed to i+1ₜₕ queue. Accordingly, the service of p₀ is not influenced by the presence of the virtual packet in the same queue. pₖ,k∈{1, . . . , K} arrives at a backlogged queue, and is thus not influenced by the presence of the virtual packet. All queues except i are always backlogged, and all queues are allocated with quantum, and the frame size is maintained at the maximum.

Putting into place a DRR scheduler that operates in the same way as the scheduler, all the traffics, except the traffic under observation i have the same arrival rates as those with the above-described scheduler but sufficiently large maximum burst sizes. Accordingly, all the other traffics are also kept in backlog state during the backlog period of i. i̅+̅1̅ₜₕ queue service starts at the start time of backlog of i. The resulting DRR system provides the same service as the above-described scheduler to all packets of i. Accordingly, Theorem 3 is given.

By Theorem 3, the delay experienced by packets in the flow aggregate i for each input port in the above-described scheduler is as below.

$${D}_{i} \leq \frac{{σ}_{i} - {L}_{i}}{{ρ}_{i}} + {Θ}_{i}^{nw \text{-} DRR}$$

where Θᵢ^{nw-DRR} is the latency of the flow aggregate i in the above-described scheduler, σᵢ and ρᵢ and are the maximum burst and the arrival rate of the flow aggregate. In the above system, the maximum burst of i in the output of the above-described scheduler is limited to ϕᵢ+Lᵢ by Theorem 2 and the properties of the LR server.

In FIG. 1, when the whole traffic of high priority outputted in the scheduler 100 provided at the output port 12 of node D 10 is I^{D}, the maximum burst of I^{D} is σ_{I}_{^{D}}=Σϕᵢ+Lᵢ , and the maximum burst σᵢ_{^{D+1}} of flow aggregate i^{D+1} from an input port 21 to each output port of a next node 20 to which I^{D} is transferred, is equal to or smaller than the maximum burst σ_{I}_{^{D}} of I^{D} since

$$\begin{matrix}{A}_{{I}^{D}} ( {t}_{0} , t ) = \sum {A}_{{i}^{D + 1}} ( {t}_{0} , t ) \\ = \sum ( {σ}_{{i}^{D + 1}} + {ρ}_{{i}^{D + 1}} ( t - {t}_{0} ) ) \\ = \sum {σ}_{{i}^{D + 1}} + \sum {ρ}_{{i}^{D + 1}} ( t - {t}_{0} ) \\ = {σ}_{{I}^{D}} + {ρ}_{{I}^{D}} ( t - {t}_{0} ) ,\end{matrix}$$

and accordingly σᵢ_{^{D+1}}≤σ_{I}_{^{D}} is given for all i^{D+1}.

The following topology may be considered for performance analysis.

1. There are six bridges between the source and the destination of the traffic.

2. Every bridge has two input ports and two output ports.

3. The traffic under observation enters the input port 1 and then departs from the output port 1.

4. A traffic with the same specification with the traffic under observation enters the input port 2 of every bridge and then leaves the output port 2 of the next node. In addition, low priority traffic also exists.

5. Parameter values used for performance analysis are as shown in Table 1.

TABLE 1

| Parameter | Value | |
|---|---|---|
| L (Max packet length, both high & low priority traffic) | 100-1500 | B |
| r (Link capacity) | 100 | Mbps |
| σᵢ (Max burst size) | 100-1500 | B |
| ρᵢ (Input data rate) | 10-20 | Mbps |
| φᵢ (Quantum size) | 10-100 | B |

In the above-described embodiment of the present disclosure, the maximum delay at the node may be calculated as the maximum delay of

$$\frac{{σ}_{i} - {L}_{i}}{{ρ}_{i}} + {Θ}_{i}^{nw \text{-} DRR} .$$

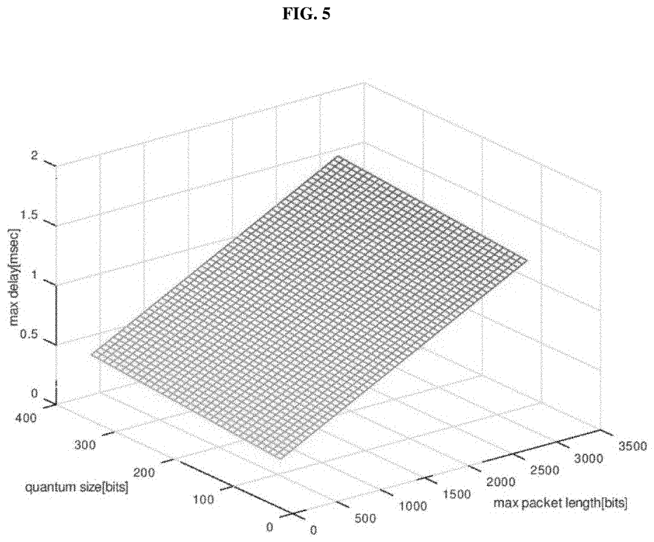

The maximum delay at subsequent nodes except the first node needs to take the varying maximum burst σᵢ of incoming traffic into account. The above-described scheduler limits the maximum burst of flow aggregate for each input port to ϕᵢ+Lᵢ. Accordingly, in this scenario, σ_{I}_{^{D}}=2(ϕᵢ+L_{H}) that equals the maximum burst of the traffic for each input port to the scheduler of the next node, namely, σᵢ_{^{D+1}}=2(ϕᵢ+L_{H}). The maximum delay summarized based on this is shown in FIGS. 4 to 6.

FIGS. 4 and 5 are diagrams showing changes in the maximum delay with the changing maximum packet size in the regulating scheduler according to an embodiment of the present disclosure.

First, FIG. 4 shows the maximum end-to-end delay of flow with varying max packet size from 400 bit to 3200 bit, flow arrival rate from 10 Mbps to 40 Mbps, and a fixed quantum value at 80 bit. It is shown that the max packet length and the input data rate are both significant parameters for the delay. The input data rate is inversely proportional to the max delay. One can consider to increase the input data rate during the connection setup phase, while actual amount of traffic remains unchanged, in order to reduce the max delay.

Meanwhile, FIG. 5 shows that the quantum size does not significantly affects the delay. When the max packet length becomes larger, the effect of the quantum value becomes even less significant. One can choose to use a relatively large quantum value in case the complexity is one of key design issues, without sacrificing the delay performance too much.

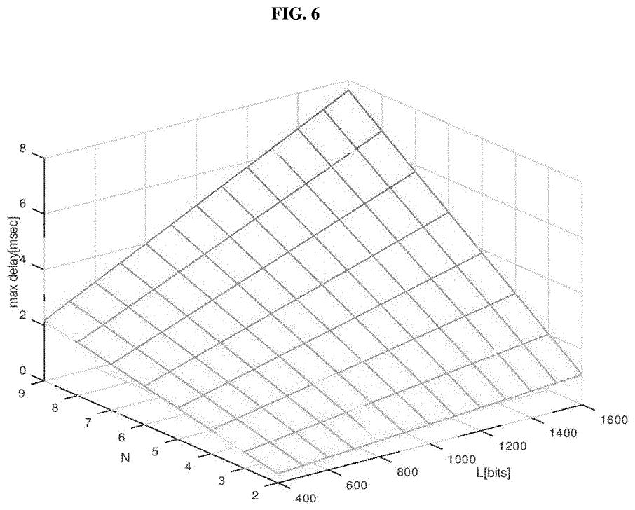

FIG. 6 is a diagram showing changes in the maximum delay with the changing quantum size in the regulating scheduler according to an embodiment of the present disclosure.

FIG. 6 shows the maximum end-to-end delay of flow with varying max packet size from 400 bit to 1600 bit, number of crossing flows from 1 to 8, fixed flow arrival rate at 10 Mbps, and a fixed quantum value at 80 bit. Referring to FIG. 6, even when the number of crossing flows is eight, which represents quite a busy network, the end-to-end delay bound can be near 2 ms if we set the maximum packet length to be less than 400 bit.

While the structure presented in the above-described experiment is simple, if the maximum packet length and the quantum size is appropriately limited, the delay of a few ms or less may be guaranteed in seven hop-networks.

As described above, according to an embodiment of the present disclosure, due to the uniform operation rate attributed to the non-work conserving characteristics, it is possible to mitigate a phenomenon in which traffic concentrates on a particular relaying node for a short time and uniformly maintain the overall traffic transmission delay. Additionally, it is possible to greatly reduce complexity by incorporating a regulator that has been maintained as an independent module into a scheduler. Meanwhile, it is possible to further reduce the complexity of implementation by performing regulation based on class, not based on flow.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A non-work conserving regulating scheduler provided at an output port of a relaying node,
wherein the scheduler performs scheduling for a plurality of first traffics having high priority on the basis of a preset reference and a second traffic having low priority on the basis of the reference according to a scheduling algorithm, the first traffics divided per input port of the relaying node,
wherein the scheduler performs scheduling by generating a virtual packet so that queue becomes non-empty, the queue in which each independent traffic of the plurality of first traffics and the second traffic is stored, and the served virtual packet is not outputted to the output port, so that the scheduler has non-work conserving characteristics.

2. The regulating scheduler of claim 1, wherein during a scheduler backlog period when there are one or more actual packets in the scheduler, all queues have to be backlogged, while some of queues are backlogged with virtual packets if there is no actual packet in the queues, as such a sum of arrival rates of all the traffics is treated as being equal to capacity of the scheduler.

3. The regulating scheduler of claim 2, wherein the scheduling algorithm is a deficit round robin (DRR) algorithm.

4. The regulating scheduler of claim 3, wherein during the scheduler backlog period to make all queues be always backlogged in which a plurality of the first traffics and the second traffic are stored, when a queue of a corresponding traffic is empty at the queue's turn for a service, a deficit value of the queue is set to a predefined value, and a virtual packet is generated.

5. The regulating scheduler of claim 4, wherein when an actual packet arrives at the queue of the corresponding traffic while the virtual packet is being served, the service of the virtual packet is stopped, the deficit value of the queue is set to a predefined value, and a next queue is served.

6. The regulating scheduler of claim 5, wherein even though the service of the virtual packet is completed, the virtual packet does not leave the scheduler.

7. The regulating scheduler of claim 6, wherein an arrival rate of a larger value than an actual arrival rate of the traffic is presented in a network.

8. The regulating scheduler of claim 6, wherein complexity is reduced by setting a quantum size to 100 Byte or above.

9. The regulating scheduler of claim 6, wherein the service order among queues is different for each scheduler backlog period.

10. A regulating scheduler of a relaying node provided at an output port of the relaying node,
wherein the scheduler performs scheduling by generating a virtual packet in a queue in which traffic is stored, to allow the queue to be continuously served more than actually incoming traffic and prevent burst from increasing due to an arbitrary queue being served all at once,
wherein the served virtual packet is not outputted to the output port, so that the scheduler has non-working-conserving characteristics.
